(19) United States
(12) Patent Application Publication
(10) Pub. No.: US 2015/0073988 A1
(43) Pub. Date: Mar. 12, 2015

(54) Methods and Systems of Facilitating Payments on a Payment Card Network

(71) Applicant: MASTERCARD INTERNATIONAL INCORPORATED, Purchase, NY (US)

(72) Inventors: Ahmed Hosny, Dublin (IE); Peter J. Groarke, Dublin (IE)

(21) Appl. No.: 14/458,705

(22) Filed: Aug. 13, 2014

(30) Foreign Application Priority Data
Aug. 14, 2013 (GB) 1314553.7

(51) Int. Cl. G06Q 20/22; G06Q 20/40

(52) U.S. Cl. CPC G06Q 20/227; G06Q 20/40
USPC 705/44; 705/39

(57) ABSTRACT

Methods and systems are provided for processing a transaction requesting payment of a first amount to a recipient. An exemplary method is performed at a network node of the system and comprises: identifying at least one payment parameter associated with the transaction; determining, in accordance with the at least one payment parameter, a plurality of account numbers associated with the transaction; and for each of the determined account numbers: determining a respective payment amount and a respective payment provider associated with the account number; and transmitting, to the determined payment provider, a subsequent request for payment of the determined payment amount.

### FIELD

The present disclosure relates to payment card systems. More particularly, it relates to methods and systems for processing a transaction conducted using a payment card system.

### BACKGROUND

In a typical transaction using a credit or debit card, a cardholder wishing to complete a transaction (or make a payment) provides a card number together with other card details (such as a card expiry date, card code verification (CCV) number etc.) to a merchant at a point of sale. The merchant transmits the card number and the details to an ‘acquirer’, i.e. a financial institution that facilitates and processes card payments made to the merchant. The acquirer then transmits an authorization request via a payment card network to an issuer or provider of the card used to make the payment.

The issuer processes the received request and determines whether or not the request is allowable. If the issuer determines that the payment request is allowable, an authorization response is transmitted via the payment card network to the acquirer and transfer of the payment amount to the merchant's account is initiated. Responsive to receiving the authorization response from the issuer, the acquirer communicates the authorization response to the merchant. In this manner, a card number may be used to effect a card payment to a merchant.

However, there are many situations where it is desirable to provide increased flexibility to fund (or pay for) purchases made on a card payment network in a manner that minimizes changes to the existing nodes or elements of the network.

### SUMMARY

In accordance with an aspect of the disclosure, there is provided a computer-implemented method of processing a transaction requesting payment of a first amount to a recipient, the method being performed at a network node of a payment card network and comprising: identifying at least one payment parameter associated with the transaction; determining, in accordance with the at least one payment parameter, a plurality of account numbers associated with the transaction; and for each of the determined account numbers: determining a respective payment amount and a respective payment provider associated with the account number; and transmitting, to the determined payment provider, a subsequent request for payment of the determined payment amount. Advantageously, this enables a group of cardholders to fund a payment made to a merchant using a single card number.

The at least one payment parameter may be indicative of an initial account number associated with the first payment request. In some embodiments, the initial account number is a virtual account number which advantageously means that a group payment can be made without exposing a personal card number belonging to any of the group.

In some embodiments, the initial account number is one of the plurality of account numbers determined in accordance with the identified parameter. In this case, the at least one identified payment parameter may be further indicative of one or more of the recipient; and the first payment amount. In this manner, one member of a group can initiate group-funded payments using a personal account number in pre-specified situations, whilst payments made in other situations will be funded from the individual's account only.

The respective payment amount and the respective payment provider associated with each of the plurality of account numbers may be determined in accordance with the at least one payment parameter. In some embodiments, determining the respective payment amount associated with each of the plurality of accounts in accordance with the at least one payment parameter comprises: dividing the first payment amount equally or unequally between the plurality of accounts. Advantageously, this enables different members of the group to pay different shares of the total payment amount.

The method may further comprise determining that a respective payment authorization has been received in response to the subsequent request for payment transmitted to each of the plurality of account numbers; and communicating, to a terminal from which the transaction was received, an indication of payment authorization.

Alternatively, the method may further comprise: determining that a payment authorization has not been received in response to a subsequent request for payment transmitted to one of the plurality of account numbers; and communicating, to a terminal from which the transaction was received, an indication of payment refusal.

If the network node determines that a payment authorization has not been received in response to a subsequent request for payment transmitted to one of the plurality of account numbers, the method may further comprise: determining that a payment authorization has been received in response to a subsequent request for payment transmitted to at least one of the plurality of accounts; and transmitting, to the payment provider associated with the at least one account, a request for reversal of the authorized payment.

In accordance with a further aspect of the disclosure, there is provided a computer-implemented method of processing a transaction requesting payment of a first amount to a recipient, the method being performed at a network node and comprising: identifying an initial account number associated with the request; responsive to determining that the initial account number is a virtual card number, determining a plurality of accounts associated with the transaction; and for each of the determined account numbers: determining a respective payment amount and a respective payment provider associated with the account number; and transmitting, to the determined payment provider, a subsequent request for payment of the determined payment amount.

In accordance with a further aspect of the disclosure, there is provided a system comprising a network node operable to process a transaction requesting payment of a first amount to a recipient, the network node being configured to: identify at least one payment parameter associated with the transaction; determine, in accordance with the at least one payment parameter, a plurality of account numbers associated with the transaction; and for each of the determined account numbers: determine a respective payment amount and a respective payment provider associated with the account number; and transmit, to the determined payment provider, a subsequent request for payment of the determined payment amount.

The network node comprised within the system may be further operable to perform any of the above-described method steps.

In accordance with a further aspect of the disclosure, there is provided a non-transitory computer-readable medium comprising instructions which, when executed, cause a processor operating at a network node to: identify at least one payment parameter associated with the transaction; determine, in accordance with the at least one payment parameter, a plurality of account numbers associated with the transaction; and for each of the determined account numbers: determine a respective payment amount and a respective payment provider associated with the account number; and transmit, to the determined payment provider, a subsequent request for payment of the determined payment amount.

The non-transitory computer-readable medium may further comprise instructions which, when executed, cause a processor operating at a network node to perform any of the above-described method steps.

In accordance with a further aspect of the disclosure, there is provided a system comprising a network node operable to process a transaction requesting payment of a first amount to a recipient, the network node being configured to: identify an initial account number associated with the request; responsive to determining that the initial account number is a virtual card number, determine a plurality of accounts associated with the transaction; and for each of the determined account numbers: determine a respective payment amount and a respective payment provider associated with the account number; and transmit, to the determined payment provider, a subsequent request for payment of the determined payment amount.

In accordance with a further aspect of the disclosure, there is provided a non-transitory computer-readable medium comprising instructions which, when executed, cause a processor operating a network node to: identify an initial account number associated with the request; responsive to determining that the initial account number is a virtual card number, determine a plurality of accounts associated with the transaction; and for each of the determined account numbers: determine a respective payment amount and a respective payment provider associated with the account number; and transmit, to the determined payment provider, a subsequent request for payment of the determined payment amount.

### DRAWINGS

Embodiments of the present disclosure will now be described, by way of example only, with reference to the accompanying drawings, in which:

FIG. 1 is a diagram of a card payment system according to an embodiment of the disclosure.

FIG. 2 is a flow diagram depicting an exemplary method of registering a group of cardholders to use the payment system of FIG. 1.

FIG. 3 is a flow diagram depicting a method of processing a payment request in accordance with embodiments of the disclosure.

FIG. 4 is a flow diagram depicting a method of responding to a payment request in accordance with embodiments of the disclosure.

FIG. 5A is a diagram of a request flow in a card payment system according to an exemplary embodiment of the disclosure.

FIG. 5B is a diagram of a response flow in a card payment system according to an exemplary embodiment of the disclosure.

A component or a feature that is common to more than one drawing is indicated with the same reference number in each of the drawings.

### DETAILED DESCRIPTION

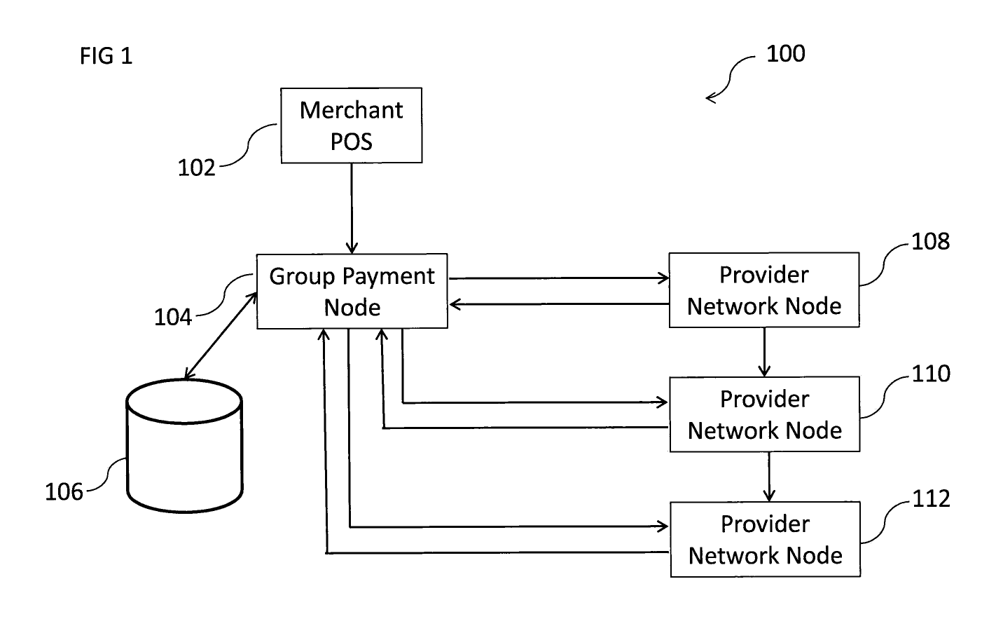

Referring to the drawings and, in particular to FIG. 1, an exemplary group payment system or group payment scheme 100 for processing group card transactions is shown. The system 100 facilitates a purchase (or transaction) using a single card number to be funded by a plurality of card numbers if a predefined set of conditions is met. In this manner, a group of cardholders can arrange for a payment made by one member of the group to be part-paid by (i.e. split between) the members of the group in a specified set of circumstances.

It will be appreciated that in the following, the term card will be used to refer to a debit and/or a credit card unless otherwise specified. As will be described in more detail below, a group payment is a payment made to a merchant using a single card number, wherein the payment is subsequently ‘split up’ or divided so that it is paid using a plurality of ‘funding cards’, i.e. a plurality of cards each of which is owned by a respective member of a group making the payment.

As discussed in more detail below, the system 100 comprises a group payment node 104 that is configured to operate on a card payment network and process a payment request made using a single card number so that the payment is funded by a group of cardholders. The group payment node 104 may be an ‘acquirer network node’ associated with (linked to, operated on behalf of, comprised within a system of etc.) a financial institution that processes (or facilitates) card payments made to a merchant. Additionally or alternatively, the group payment node 104 may be one or more of a network node associated with (linked to, operated on behalf of, comprised within a system of etc.) a card issuer (or provider) and a card payment network node associated with a third party operating as, or in association with, a group payment provider.

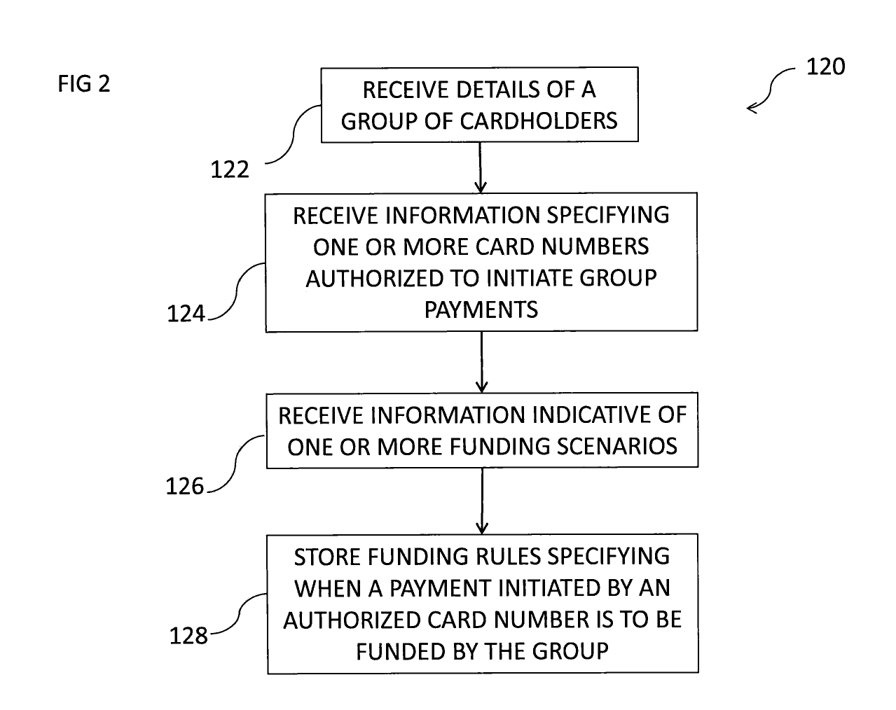

Prior to using the system 100, two or more cardholders (i.e. a ‘group’ of cardholders) wishing to make one or more group payments register to use the system 100. FIG. 2 depicts an exemplary method 120 of registering a group of cardholders to use the system 100. The registration process 120 may be performed by the group payment node 104. Additionally or alternatively, the registration process may be performed (or part-performed) by one or more other nodes in a card payment network. For example, the registration process may be performed by a card issuer, an acquirer or a third party operating in association with a group payment provider.

At block 122, the group payment node 104 receives details of a group of cardholders wishing to use the group payment system 100. The details are received via a registration interface (not shown) which may be provided in any suitable manner. For example, the registration interface may be provided online via a provider website (not shown), via a telephone service, in person, etc. In some embodiments, cardholders may register to use the group payment system 100 at a point of sale, in which case the registration interface may be provided by a merchant terminal 102.

It will be appreciated that members of a group may provide registration information via the same interface and/or at the same time, e.g. during a single registration ‘session’ where each of the group members provides his/her respective details in turn before completion of the registration. Additionally or alternatively, one or more members of the group may provide his/her respective details at a different time and/or using a different registration interface. In this case, the group payment node 104 may subsequently link the registration information provided by the respective group members.

The details received at block 122 comprise information necessary to authorize a payment from the respective cards of the group of cardholders. In particular, the details received in respect of each of the cardholders comprise the card number associated with the cardholder's account (e.g. the card number that appears on a physical card issued to the cardholder). Additionally, the details received in respect of each of the cardholders may comprise any other information relating to the card or cardholder. For example, the received details may comprise information indicative of one or more of: the cardholder's name and/or date of birth; the expiry date of the card; the issue date of the card; the cardholder's address; the credit card verification (CCV) number of the card; and a response to a security question previously set by the cardholder.

At block 124, the group payment node 104 receives information specifying one or more of the plurality of card numbers provided at block 122, wherein the specified one or more card numbers are authorized by each of the group members to initiate payments that will be funded by the group. In this manner, members of a group can nominate/elect one or more members that are authorized to make payments on behalf of the group. Whilst the cards of the other group members will be used to fund any such group payments, these other cards are not authorized to initiate a group payment.

At block 126, the group payment node 104 receives information indicative of one or more ‘funding scenarios’ or situations in which a payment made using the one or more card numbers specified at block 124 may be used to initiate a group payment (i.e. make a payment that is funded by the group). Such situations may include, for example that: every time the one or more specified card numbers is used to initiate a transaction (e.g. members of a club may wish to split any payments made using one or more club credit cards etc.) the costs of the transaction are spread among the members of the group; when a specified amount is to be paid from the one or more specified card numbers (e.g. housemates may wish to split a specific amount that is paid in rent) the costs of the transaction are spread among the members of the group; when a payment to a specific merchant is to be made from the one or more specified card numbers (e.g. a group of housemates may wish to split all payments made to an electricity company) the costs of the transactions are spread among the members of the group; and that when a payment is to be made at a given time and/or location from the one or more specified card numbers (e.g. club members may wish to split any payments made during a club outing) the costs of the transactions are spread among the members of the group. Any other suitable scenarios or situations may also be registered as situations in which a payment is to be split between two or more members of a group.

The information received at block 126 may also comprise an indication of a number of times a group payment can be made using the specified card number. For example, members of a group may wish to make a once-off group payment only. Alternatively, the group members may wish to make a predefined number of payments and/or make payments at regular or irregular intervals indefinitely or over a predefined period of time. In this case, the details provided on registration may be updated or modified at any stage.

At block 128, the group payment node 104 stores the information received at blocks 122 to 126 in one or more databases 106. The received information may be stored as one or more funding parameters specifying the conditions that must be met for a payment initiated by the one or more specified card numbers to be funded by the members of the group. The stored funding parameters may be accessed by a node of a payment card network during processing of a transaction requesting payment (a payment request). The one or more databases 106 may comprise any suitable storage means accessible by a secured wired or wireless connection. For example, the one or more databases 106 may be accessible via the cloud.

A cardholder registered to use the group payment system 100 and authorized to make a group payment on behalf of the group, initiates a group payment to a merchant (which may be a business, association, charity, individual, etc.) at a merchant terminal 102. The merchant terminal 102 may be a physical terminal, e.g. the terminal may be located at a physical point of sale such as a shop or restaurant. Alternatively, the merchant terminal 102 may be a virtual terminal associated with a virtual point of sale, e.g. a point of sale at which online purchases or payments are made. In some embodiments, the merchant terminal 102 may be an application running on a device such as a portable telephone or computer (e.g. a ‘smartphone’ or tablet computer).

The cardholder initiates the transaction in the same manner as a ‘regular’ card transaction would be initiated. For example, the cardholder may provide details of the total payment amount, i.e. the amount of money that is to be transferred or paid to the merchant together with details of a card number being used to make the payment, and any other necessary details of the card associated with the card number. Alternatively, the cardholder may provide some or all of the payment details manually, e.g. by entering the required values on an online or hardcopy of a payment form and/or providing the details over the telephone. Additionally or alternatively, the cardholder may provide some or all of the payment details via a card reader e.g. by swiping the card, inserting the card in the reader or placing the card sufficiently close to the reader for the details to be transmitted.

The card number provided to the merchant may be a number of a physical (regular or actual) card, e.g. a number printed on the cardholder's card and linked to the cardholder's account.

The card number provided to the merchant may additionally or alternatively be a virtual card number (a dynamic credit card number, a controlled payment number, an alias number, a one-time use credit card number, a substitute credit card number, a rechargeable credit card number, etc.). A virtual card number is generated by a card issuer and is linked to at least one physical card number and account. The virtual card number may, for example, be generated via a Web application or a specialized client program provided by, or associated with, an issuer of the physical card number to which the virtual card number is linked. A virtual card number can be created for each payment thereby avoiding the need for any member of the group to expose his/her personal card number to the merchant.

Responsive to receiving the card details, the merchant terminal 102 transmits or communicates an authorization (or payment) request to the payment processor or group payment node 104 for processing. The authorization request may be transmitted in any suitable manner, e.g. via a wired or wireless connection.

In an exemplary embodiment, a merchant wishing to provide group payment functionality to its customers may register with the group payment provider. In this case, the group payment node 104 may act as a ‘pseudo-acquirer’ and facilitate or process any group payments made to the merchant.

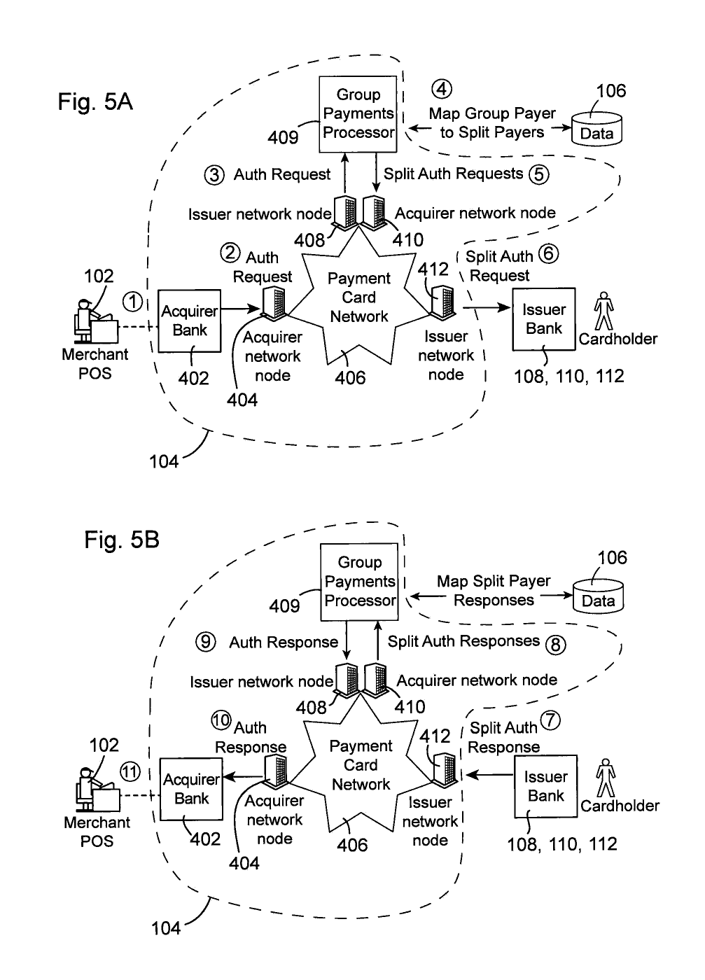

In what follows a single group payment node 104 will be referred to. However, it will be appreciated that, as shown in FIGS. 5A and 5B, this node may comprise multiple individual nodes at which the authorization request is processed and/or re-transmitted.

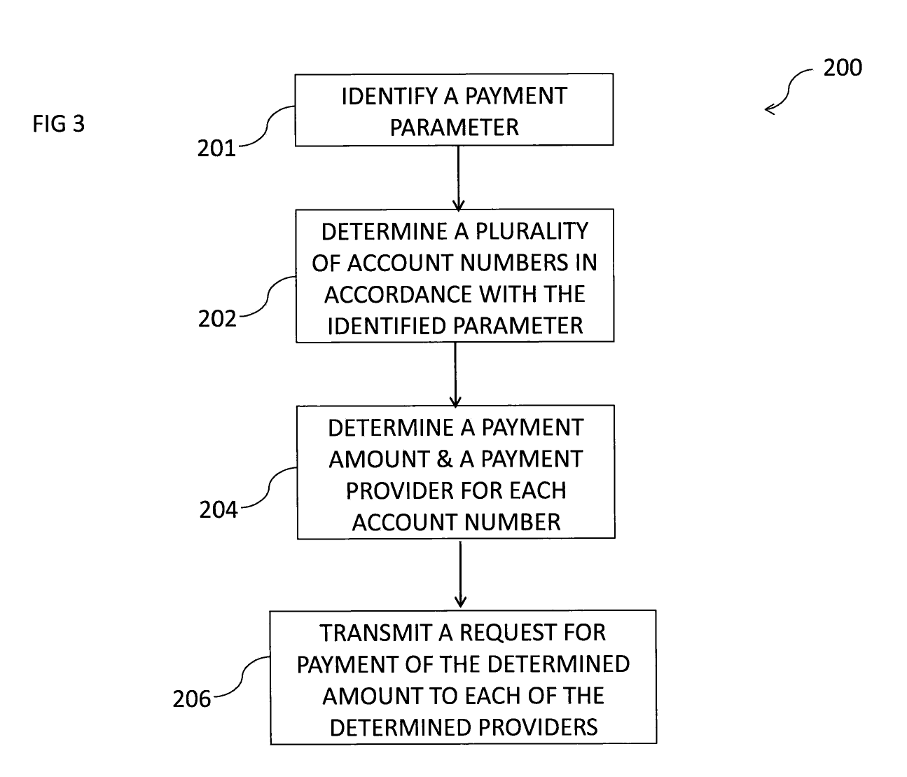

Responsive to receipt of the authorization request, the group payment node 104 processes the authorization request by performing a method 200 which will now be described in relation to FIG. 3. The processing steps performed by the group payment node 104 may be performed by any suitable processing circuitry. For example, the method 200 may be performed by one or more processors operating at, or in association with, the group payment node 104.

At block 201, the group payment node 104 identifies one or more parameters that are associated with the authorization request and determines that the identified parameters indicate that the payment is to be divided between a group of cardholders (i.e. the payment is to be funded from the cardholder's accounts).

The one or more identified parameters may be indicative of any of the situations indicated by the group cardholders during registration. For example, in the situations described above, the identified parameters may comprise one or more of: the card number used to initiate the transaction either alone or in combination with one or more of: the payment amount specified in the transaction; the merchant to whom the payment is being made; and the time and/or location at which the transaction took place. The group payment node 104 may identify the parameter using any suitable means.

In some embodiments, the identified parameter may be the card number used to initiate the payment. In this case, the group payment node 104 may determine whether the card number used to initiate the transaction is registered for use with the group payment system 100. The group payment node 104 may, for example, perform this determination by accessing a list of registered card numbers stored in the one or more databases 106 and determining whether the card number used to initiate the payment is comprised within this list.

Responsive to determining that the card number is registered for use with the group payment system 100, the group payment node 104 may access further information or rules that are stored in the database 106 in association with the card number. Based on this information, the group payment node 104 may determine whether the characteristics of the received authorization request meet a specified scenario for dividing the payment between a plurality of cardholders.

For example, based on the information stored in the database 106, the group payment node 104 may determine that one or more of: the payment amount specified in the transaction; the merchant to whom the payment is being made; and the time and/or location at which the transaction took place meet the conditions specified by the cardholder(s) during registration. In this manner, transactions initiated using a personal card number of one member of a group can be funded using the card numbers of all the group members as long as the details of the initiated transaction meet the requirements specified by the group members during registration. Transactions initiated using the personal card number but not meeting the specified requirements will be funded directly from the account associated with the personal card number in the usual manner. Hence, group payments can be facilitated without the need for group members to obtain a specific card for the purpose.

In some embodiments, the identified parameter may be the card number used to initiate the payment. In this case, the group payment node 104 may determine whether the card number used to initiate the transaction is registered for use with the group payment system 100. The group payment node 104 may, for example, perform this determination by accessing a list of registered card numbers stored in the one or more databases 106 and determining whether the card number used to initiate the payment is comprised within this list.

In an exemplary embodiment in which the card number used to initiate the transaction is a virtual card number, the identified parameter may comprise the card number itself. In this case, the virtual card number may be generated automatically during the group payment registration process. Alternatively, a previously generated virtual card number may be linked to or associated with a group of cardholders wishing to make group payments during the registration process.

At block 202 the group payment node 104 determines a plurality of card/account numbers (or cardholder identities) in accordance with the identified parameter. The group payment node 104 may determine the card numbers associated with the group payment in any suitable manner. For example, based on the identified parameter, the group payment node 104 may access a list of associated card numbers stored in the database 106.

As discussed above in relation to the card number used to initiate the transaction, the plurality of card numbers associated with the group payment may comprise one or more physical/actual card numbers and/or one or more virtual card numbers. The group payment node 104 determines a provider associated with each of the plurality of card numbers in the same manner as if the card number were used to initiate the transaction.

At block 204 the group payment node 104 determines a payment amount and a payment provider associated with each of the respective card numbers. The group payment node 104 may determine the respective payment providers in the same manner in which providers are determined during a ‘regular’ card transaction.

The group payment node 104 may determine the respective payment amounts in any suitable manner. For example, the group payment node 104 may determine that the payment amount specified in the authorization request transmitted by the merchant terminal 102 is to be divided equally amongst the plurality of members of the group (i.e. the plurality of card numbers). In this case, where necessary, the group payment node 104 may ‘round-up’ or ‘round-down’ the divided amounts between the plurality of card numbers.

Additionally or alternatively, the group payment node 104 may determine the respective payment amounts in accordance with a predefined rule. For example, the group members may specify a payment ratio or division rule when registering to use the group payment system 100. In this manner, different members of the group can pay different amounts of the overall payment. For example, a housemate with a larger bedroom (or an ensuite) may elect to pay a larger share of monthly rent than other housemates in the group; or members of a club participating in an event for different periods of time may pay their share of the event costs in accordance with their period of participation.

At block 206, the group payment node 104 transmits an authorization request to a respective provider (or issuer) 108, 110, 112 associated with each of the plurality of card numbers. It will be appreciated that one or more of the plurality of card numbers may be issued by the same provider. Alternatively, each of the card numbers may be issued by a different respective provider.

As discussed above in relation to the initial payment request, the group payment node 104 may transmit the plurality of authorization requests in any suitable manner. For example, the group payment node 104 may transmit the authorization request to an ‘acquirer’ network node. In this case, the acquirer node may then transmit individual authorization requests to the respective providers 108, 110, 112 associated with each of the card numbers. Additionally or alternatively, the group payment node 104 may transmit each of the authorization requests directly to the respective provider (or issuer) network nodes 108, 110, 112) and/or via one or more intermediary network nodes.

In the exemplary embodiment depicted in FIG. 1, three provider network nodes 108, 110, 112) are depicted. However, it will be appreciated that more or fewer than three network nodes might equally be used. Similarly, it will be appreciated that one or more of the plurality of card numbers may be associated with a given provider network node 108, 110, 112.

The provider network nodes 108, 110, 112 may process the authorization requests from the group payment node 104 in the same manner as a ‘regular’ authorization request for the associated card number. Accordingly, each of the provider network nodes 108, 110, 112 can process a respective authorization request as though the associated card number were used to initiate a transaction for the specified amount at the merchant terminal 102. In this manner, the processing performed by the group payment node 104 may be hidden or separate from the provider network nodes 108, 110, 112.

In some embodiments, the provider network nodes 108, 110, 112 receiving the authorization requests from the group payment node 104 determine that the requests relate to a group payment and process the requests accordingly. For example, the provider network nodes 108, 110, 112 may determine that the request relates to a group payment request based on the group payment node 104 from which the request was received. Additionally or alternatively, the group network node 104 may include a flag or parameter in the transmitted request to enable the provider network nodes 104 to determine that the request relates to a group payment.

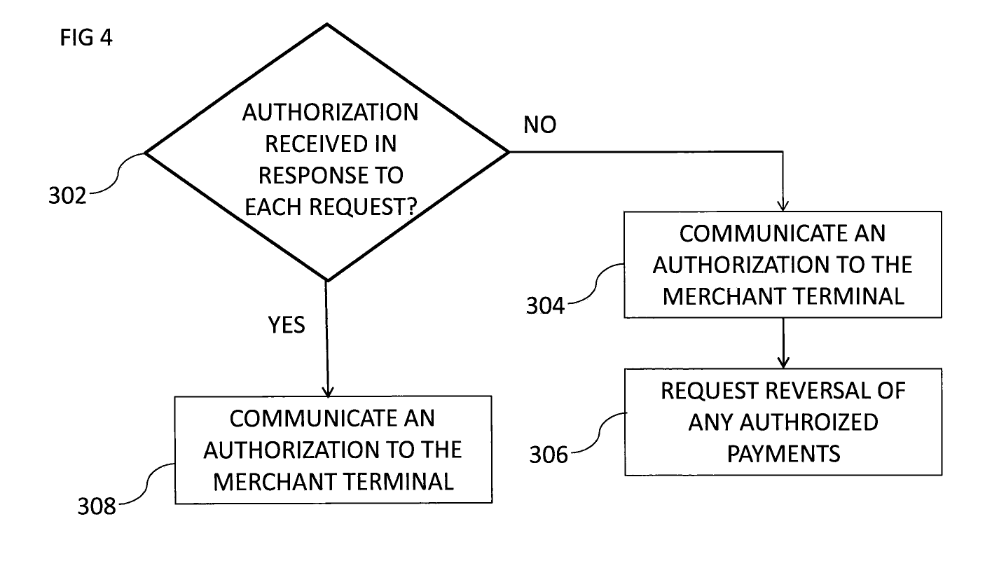

FIG. 4 depicts a method 300 for processing the responses received by the group payment node 104 from the provider nodes 108, 100, 112. In what follows, the method 300 will be described as being performed by the same group payment node 104 that performed the method 200. However, it will be appreciated that some or all of the steps of the method 300 may equally be performed by one or more other payment processing nodes.

At block 302, the group payment node 104 determines whether or not an authorization has been received in response to each of the requests sent to the provider nodes 108, 110, 112. The group payment node 104 may perform this determination a predefined amount of time after transmission of the authorization requests. If the group payment node 104 determines that an authorization has not been received in response to each of the requests transmitted at block 206, the group payment node 104 may repeat this step at regular or irregular periods for a predefined length of time after transmission of the request. In this case, if an authorization response has not been received from one or more of the providers 108, 110, 112, on expiry of the predefined period, processing continues at block 304 at which the initial request for payment received from the merchant terminal 102 is refused (or has been declined).

In some embodiments, in addition to or alternatively to waiting for a predetermined period to receive a response from each of the providers 108, 110, 112, the group payment node 104 may determine that a refusal has been received in response to one or more of the transmitted authorization requests (i.e. one or more of the transmitted authorization requests has been declined). In this case, processing may proceed directly to block 304 without waiting for expiry of the predetermined period or waiting for any further responses from the providers 108, 110, 112.

At block 306, the group payment node 104 determines whether an authorization has been received in response to any of the transmitted authorization requests and, if so, transmits a request for reversal of the payment to the provider 108, 110, 112 from which the response has been received. In this manner, if payment is refused in respect of one of the plurality of card numbers no payment will be taken from accounts associated with any of the other card numbers.

Responsive to determining that a respective authorization has been received in response to each of the transmitted authorization requests, at block 308 the group payment node 104 communicates an authorization to the merchant terminal 102. The authorization may be communicated to the merchant terminal 102 in any suitable manner. For example, the authorization may be transmitted to an acquirer node which then transits an authorization to the merchant terminal 102. Alternatively, the group payment node 104 may transmit the authorization directly, or via any other processing node, to the merchant terminal 102.

In an exemplary embodiment in which the provider network nodes 108, 110, 112 determine that the received authorization requests relate to a group payment, the provider nodes may transmit a ‘pre-authorization’ response to the group payment node 104. In this case, the pre-authorization response is indicative that the payment can be authorized if required (e.g. that the card details provided are valid and the specified payment amount can be made using this card). However, the provider network nodes 108, 110, 112 do not initiate payment at this stage.

Responsive to determining that a pre-authorization response has been received in respect of each of the authorization requests transmitted at block 206, the group payment node 104 transmits a further (or final) authorization request to the provider network nodes 108, 110, 112. The provider network nodes 108, 110, 112 then initiate payment in response to this further request. On the other hand, if the group payment node 104 does not receive a pre-authorization response in respect of one or more of the authorization requests transmitted at block 206, the group payment node 104 does not transmit any further authorization request to the provider network nodes 108, 110, 112 which will not then initiate payment in respect of any of the card numbers.

FIG. 5A depicts a request processing flow in accordance with an exemplary embodiment of the disclosure. A transaction is initiated using a card number. As discussed previously, the card number may be a physical or virtual number and may be associated with any type of credit, debit or store purchase card. At step 1, the merchant terminal 102 processes the transaction by transmitting details of the transaction to an acquirer bank 402 that the merchant uses to processes card payments made to the merchant.

Responsive to receiving the request from the merchant terminal 102, the acquirer bank 402 transmits an authorization request to a network node 404 associated with the acquirer bank. The acquirer network node 404 then transmits the authorization request via a wired or wireless payment card network 406 to an issuer network node 408. As described in relation to block 202 of method 200, the issuer network node 408 identifies that the transaction is a group payment (i.e. is to be funded from the accounts of a plurality of cardholders) and transmits the request to the group payments processor 409 at step 3.

Based on information stored in the database 106, at step 4, the group payment processor 409 identifies a plurality of card numbers associated with the transaction and a respective amount to be paid by each of the plurality of card numbers. At step 5, the group payment processor 409 transmits a plurality of authorization requests to an acquirer network node 410, wherein the plurality of authorization requests comprise a request in respect of each of the determined card numbers for the determined respective amount.

The group payment processor 409 then transmits the plurality of authorization requests via the payment card network 406 to an issuer network node 412. At step 6, the issuer network node 412 transmits each of the plurality of authorization requests to a respective Issuer bank 108, 110, 112 of the card number specified in the request.

FIG. 5B depicts a response processing flow in accordance with an exemplary embodiment of the disclosure. At step 7, one or more of the issuer banks 108, 110, 112 transmit an authorization response to the issuer network node 412. Responsive to determining that one or more authorization responses have been received, the issuer network node 412 transmits the received responses via the payment card network 406 to an acquirer network node 410.

At step 8, the acquirer network node 410 transmits the received responses to the group payment processor 409. Based on information stored in the database 106 (e.g. information stored by the cardholders participating in the group payment when registering to use the group payment system 100) the group payment processer 409 determines whether an authorization response has been received in respect of each of the card numbers associated with the group payment.

Responsive to determining that an authorization response has been received in respect of each of the card numbers, at step 9 the group payment processor 409 transmits an authorization response to the issuer network node 408. The issuer network node 408 then transits an authorization response via the payment card network to the acquirer network node 404.

At step 10, the acquirer network node 404 transmits an authorization response to the acquirer bank 402 which in turn provides an authorization response to the merchant terminal 102.

It will be understood that the present disclosure may be embodied in a computer readable non-transitory storage medium storing instructions of a computer program which when executed by a computer system results in performance of steps of the method described herein. Such storage media may include any of those mentioned in the description above.

The terms “comprises” or “comprising” are to be interpreted as specifying the presence of the stated features, integers, steps or components, but not precluding the presence of one or more other features, integers, steps or components or groups thereof.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

1. A computer-implemented method of processing a transaction requesting payment of a first amount to a recipient, the method being performed at a network node and comprising:
identifying at least one payment parameter associated with the transaction;
determining, in accordance with the at least one payment parameter, a plurality of account numbers associated with the transaction; and
for each of the determined account numbers:
determining a respective payment amount and a respective payment provider associated with the account number; and
transmitting, to the determined payment provider, a subsequent request for payment of the determined payment amount.

2. The method of claim 1, wherein the at least one payment parameter is indicative of an initial account number associated with the first payment request.

3. The method of claim 2, wherein the initial account number is a virtual card number.

4. The method of claim 1, wherein the initial account number is one of the plurality of account numbers.

5. The method of claim 4, wherein the at least one payment parameter is further indicative of one or more of:
the recipient; and
the first payment amount.

6. The method of claim 1, wherein the respective payment amount and the respective payment provider associated with each of the plurality of account numbers are determined in accordance with the at least one payment parameter.

7. The method of claim 1, further comprising:
determining that a respective payment authorisation has been received in response to the subsequent request for payment transmitted to each of the plurality of account numbers; and
communicating, to a terminal from which the transaction was received, an indication of payment authorisation.

8. The method of claim 1, further comprising:
determining that a payment authorisation has not been received in response to a subsequent request for payment transmitted to one of the plurality of account numbers; and
communicating, to a terminal from which the transaction was received, an indication of payment refusal.

9. The method of claim 8, further comprising:
determining that a payment authorisation has been received in response to a subsequent request for payment transmitted to at least one of the plurality of accounts; and
transmitting, to the payment provider associated with the at least one account, a request for reversal of the authorised payment.

10. The method of claim 1, wherein determining the respective payment amount associated with each of the plurality of accounts in accordance with the at least one payment parameter comprises dividing the first payment amount equally or unequally between the plurality of accounts.

11. A computer-implemented method of processing a transaction requesting payment of a first amount to a recipient, the method being performed at a network node and comprising:
identifying an initial account number associated with the request;
responsive to determining that the initial account number is a virtual card number, determining a plurality of accounts associated with the transaction; and
for each of the determined account numbers:
determining a respective payment amount and a respective payment provider associated with the account number; and
transmitting, to the determined payment provider, a subsequent request for payment of the determined payment amount.

12. A system comprising a network node operable to process a transaction requesting payment of a first amount to a recipient, the network node being configured to:
identify at least one payment parameter associated with the transaction;
determine, in accordance with the at least one payment parameter, a plurality of account numbers associated with the transaction; and
for each of the determined account numbers:
determine a respective payment amount and a respective payment provider associated with the account number; and
transmit, to the determined payment provider, a subsequent request for payment of the determined payment amount.

13. (canceled)

14. A system comprising a network node operable to process a transaction requesting payment of a first amount to a recipient, the network node being configured to:
identify an initial account number associated with the request;
responsive to determining that the initial account number is a virtual card number, determine a plurality of accounts associated with the transaction; and
for each of the determined account numbers:
determine a respective payment amount and a respective payment provider associated with the account number; and
transmit, to the determined payment provider, a subsequent request for payment of the determined payment amount.

15. (canceled)
